(19) United States
(12) Patent Application Publication
(10) Pub. No.: US 2026/0147098 A1
(43) Pub. Date: May 28, 2026

(54) STRUCTURE LIGHT DEPTH SENSING SYSTEM AND METHOD USING AUXILIARY TIME-OF-FLIGHT SENSING

(71) Applicant: HIMAX TECHNOLOGIES LIMITED, Tainan City (TW)

(72) Inventors: Wu-Feng CHEN, Tainan City (TW); Hsueh-Tsung LU, Tainan City (TW)

(21) Appl. No.: 18/960,681

(22) Filed: Nov. 26, 2024

(51) Int. Cl. G01S 7/4865; G01S 7/489; G01S 17/894

(52) U.S. Cl. CPC G01S 7/4866; G01S 7/489; G01S 17/894

(57) ABSTRACT

A structure light depth sensing system and a structure light depth sensing method using auxiliary time-of-flight sensing are provided. The structure light depth sensing system includes a time-of-flight depth sensing circuit and a structure light depth sensing circuit. The structure light depth sensing method includes: providing similarity values in a predetermined search range, in which the predetermined search range includes a largest similarity value; calculating a compensation range in the predetermined search range in accordance with a target depth value of depth data of the time-of-flight depth sensing circuit; calculating compensated similarity values in accordance with a weighting gain and the similarity values in the compensation range; and determining if a maximum value among the compensated similarity values is greater than the largest similarity value. When the determination result is yes, the maximum value among the compensated similarity values is determined to be a correct similarity value.

### BACKGROUND

### Field of Invention

The present invention relates to a structure light depth sensing system and a structure light depth sensing method using auxiliary time-of-flight sensing.

### Description of Related Art

With the rapid advancement of technology in recent years, electronic products such as PCs, tablet PCs, NBs, and smartphones have become indispensable in our daily lives. The electronic product may have a function of 3D sensing to, for example provide 3D images of an object. A structure light depth sensing system is a common 3D sensing system for obtaining depth data of the object. In general, the structure light depth sensing system projects a structure light on the object and senses reflected light from the object, thereby calculating the depth data of the object.

However, in a case that the surface of the object has patterns having repeat cycle or great height differences, the structure light depth sensing system may calculate wrong depth data of the object when sensing the object. For example, a wrong similarity/disparity value is calculated for calculation of depth data.

### SUMMARY

Embodiments of the present invention provide a structure light depth sensing system and a structure light depth sensing method using auxiliary time-of-flight sensing. The time-of-flight sensing can help the structure light depth sensing system to overcome the problems caused from the patterns having repeat cycle or great height differences, thereby enabling the structure light depth sensing system to calculate correct depth data of the object having the patterns.

In accordance with embodiments of the present invention, the structure light depth sensing system using auxiliary time-of-flight sensing includes a time-of-flight depth sensing circuit and a structure light depth sensing circuit. The time-of-flight depth sensing circuit is configured to perform a depth sensing operation on an object to generate a depth data corresponding to plural positions on a surface of the object. The depth data includes plural depth values corresponding to the positions of the object. The structure light depth sensing circuit is configured to generate depth data corresponding to the positions on the surface of the object in accordance with the depth data of the time-of-flight depth sensing circuit. The structure light depth sensing includes a compensation circuit configured to perform: providing a plurality of similarity values in a predetermined search range, in which the predetermined search range includes a largest similarity value; calculating a compensation range in the predetermined search range in accordance with a target depth value of the depth data of the time-of-flight depth sensing circuit; calculating plural compensated similarity values in accordance with a weighting gain and the similarity values in the compensation range; and determining if a maximum value among the compensated similarity values is greater than the largest similarity value. When the maximum value among the compensated similarity values is greater than the largest similarity value, the maximum value among the compensated similarity values is determined to be a correct similarity value, and the largest similarity value is determined to be a wrong similarity value.

In some embodiments, the similarity values are calculated by using normalized cross correlation.

In some embodiments, a value of the weighting gain is substantially equal to 1.2.

In some embodiments, when the compensation circuit performs calculating the compensated similarity values in accordance with the weighting gain and the similarity values in the compensation range, the compensation circuit performs: multiplying each of the similarity values in the compensation range by the weighting gain to obtain the compensated similarity values.

In some embodiments, the structure light depth sensing system using auxiliary time-of-flight sensing further comprises: a light projector electrically connected to the time-of-flight depth sensing circuit and the structure light depth sensing circuit to be switched to provide different lights for the time-of-flight depth sensing circuit and the structure light depth sensing circuit.

In some embodiments, the compensation range is substantially equal to 10 pixels.

In some embodiments, when the maximum value among the compensated similarity values is not greater than the largest similarity value, the largest similarity value is determined to be a correct similarity value.

In some embodiments, the structure light depth sensing circuit us further configured to calculate a depth value in accordance with the correct similarity value.

In accordance with embodiments of the present invention, the structure light depth sensing method using auxiliary time-of-flight sensing includes: providing a plurality of similarity values in a predetermined search range, wherein the predetermined search range comprises a largest similarity value; calculating a compensation range in the predetermined search range in accordance with a target depth value of depth data of a time-of-flight depth sensing circuit; calculating plural compensated similarity values in accordance with a weighting gain and the similarity values in the compensation range; and determining if a maximum value among the compensated similarity values is greater than the largest similarity value. When the maximum value among the compensated similarity values is greater than the largest similarity value, the maximum value among the compensated similarity values is determined to be a correct similarity value, and the largest similarity value is determined to be a wrong similarity value.

In some embodiments, the similarity values are calculated by using normalized cross correlation.

In some embodiments, a value of the weighting gain is substantially equal to 1.2.

In some embodiments, calculating the compensated similarity values in accordance with the weighting gain and the similarity values in the compensation range includes: multiplying each of the similarity values in the compensation range by the weighting gain to obtain the compensated similarity values.

In some embodiments, the compensation range is substantially equal to 10 pixels.

In some embodiments, when the maximum value among the compensated similarity values is not greater than the largest similarity value, the largest similarity value is determined to be a correct similarity value.

In some embodiments, the structure light depth sensing method using auxiliary time-of-flight sensing further includes: calculating a depth value in accordance with a correct similarity value corresponding to the correct similarity value.

### BRIEF DESCRIPTION OF THE DRAWINGS

The invention can be more fully understood by reading the following detailed description of the embodiment, with reference made to the accompanying drawings as follows:

FIG. 1 is a schematic diagram showing functional blocks of a structure light depth sensing system in accordance with embodiments of the present invention.

FIG. 2 is a schematic diagram showing a structure of the light projector 130 in accordance with embodiments of the present invention.

FIG. 3 is a schematic diagram showing patterns of ground truth of the object to be measured in accordance with embodiments of the present invention.

FIG. 4 is schematic diagram showing a flow chart of a structure light depth sensing method 400 in accordance with embodiments of the present invention.

FIG. 5 is a schematic diagram showing plural positions in a predetermined search range in accordance with embodiments of the present invention.

FIG. 6 is a schematic diagram showing the disparity values of the positions in a predetermined search range in accordance with embodiments of the present invention.

FIG. 7 is a schematic diagram showing the weighting gain compensation in accordance with embodiments of the present invention.

FIG. 8 is a schematic diagram showing wrong depth of the surface of the object and correct depth of the surface of the object in accordance with embodiments of the present invention.

In accordance with customary practice, the various features and elements in the drawings are not drawn to scale, but are drawn in a manner that best represents the specific features and elements relevant to the present disclosure. Furthermore, among the different drawings, similar elements/components are referred to by the same or similar reference numerals.

### DETAILED DESCRIPTION

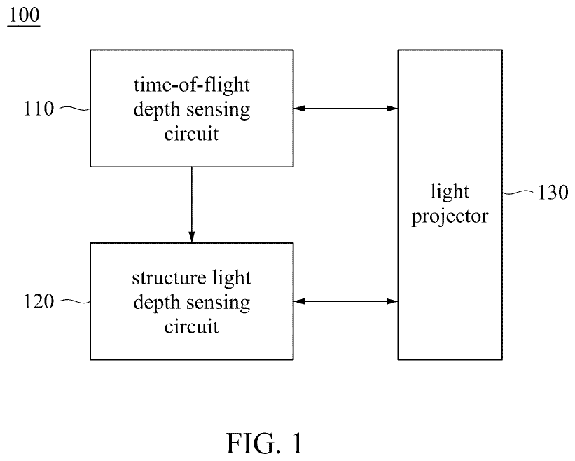

Referring to FIG. 1, FIG. 1 is a schematic diagram showing functional blocks of a structure light depth sensing system 100 in accordance with embodiments of the present invention. The structure light depth sensing system 100 includes a time-of-flight depth sensing circuit 110, a structure light depth sensing circuit 120 and a light projector 130. The time-of-flight depth sensing circuit 110 is configured to perform a depth sensing operation on an object desired to be measured to generate a depth data corresponding to plural positions on a surface of the object, in which the depth data includes plural depth values corresponding to the positions of the object. The structure light depth sensing circuit 120 is configured to generate depth data corresponding to the positions on the surface of the object in accordance with the depth data of the time-of-flight depth sensing circuit 110. In this embodiment, the structure light depth sensing circuit 120 includes a compensation circuit (not shown) to use the depth data of the time-of-flight depth sensing circuit 110 to compensate the depth data of the structure light depth sensing circuit 120.

The light projector 130 is electrically connected to the time-of-flight depth sensing circuit 110 and the structure light depth sensing circuit 120 for the depth sensing operation of the time-of-flight depth sensing circuit 110 and the structure light depth sensing circuit 120.

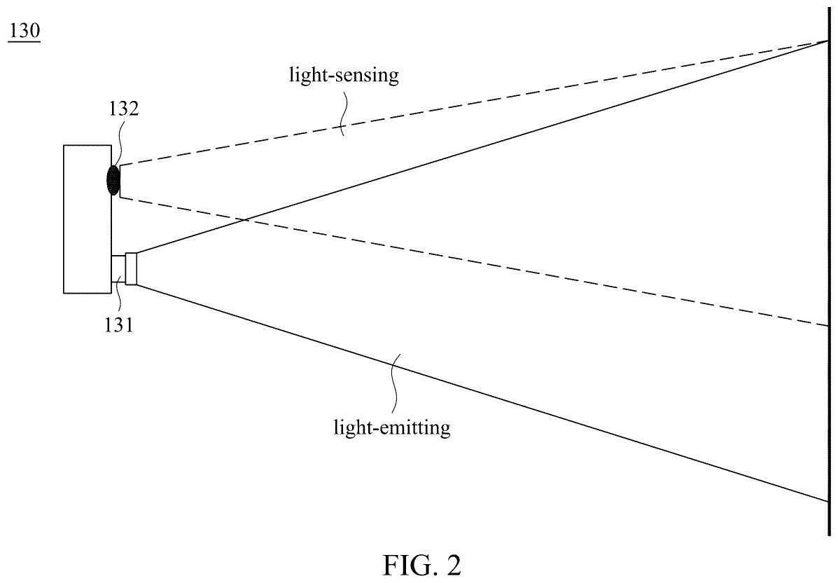

Referring FIG. 2, FIG. 2 is a schematic diagram showing a structure of the light projector 130 in accordance with embodiments of the present invention. The light projector 130 includes a light source 131 and a light sensor 132. The light source 131 is configured to emit light to the object and the light sensor 132 is configured to sense reflected light, thereby performing the depth sensing of the time-of-flight depth sensing circuit 110/the structure light depth sensing circuit 120 on the object. In some embodiments, the light projector 130 uses a liquid crystal lens (LC lens) to switch the light source 131 to provide the lights desired by the time-of-flight depth sensing circuit 110 and the structure light depth sensing circuit 120.

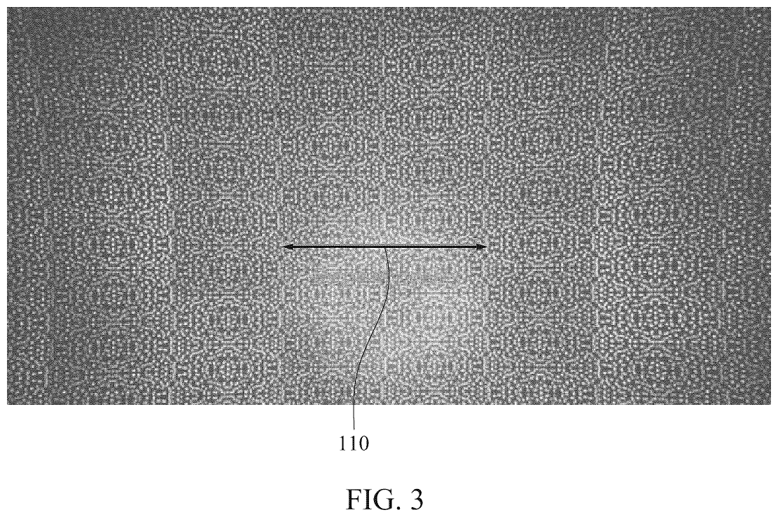

In this embodiment, the surface the object desired to be measured may have patterns having repeat cycle and/or great height differences. Referring to FIG. 3, FIG. 3 is a schematic diagram showing patterns of ground truth of the object to be measured in accordance with embodiments of the present invention. The patterns of the surface of the object desired to be measured include a repeat cycle 310. The repeat cycle 310 may result in error depth sensing for a conventional structure light depth sensing system.

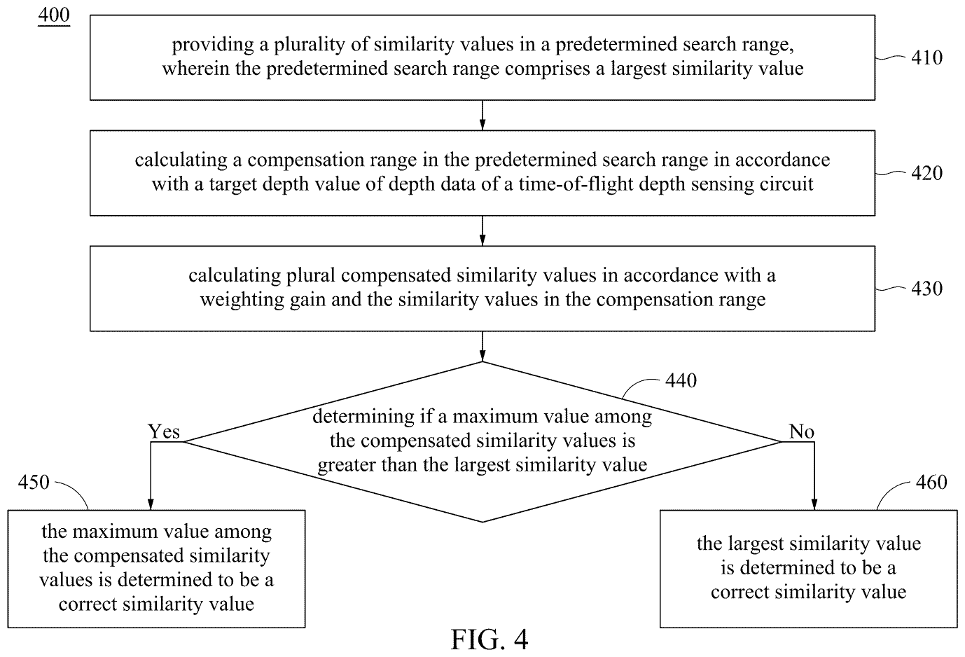

Referring to FIG. 4, FIG. 4 is schematic diagram showing a flow chart of a structure light depth sensing method 400 in accordance with embodiments of the present invention. The structure light depth sensing method 400 is adapted for the compensation circuit of the structure light depth sensing circuit 120 to use the depth data of the time-of-flight depth sensing circuit 110 to compensate the depth data of the structure light depth sensing circuit 120.

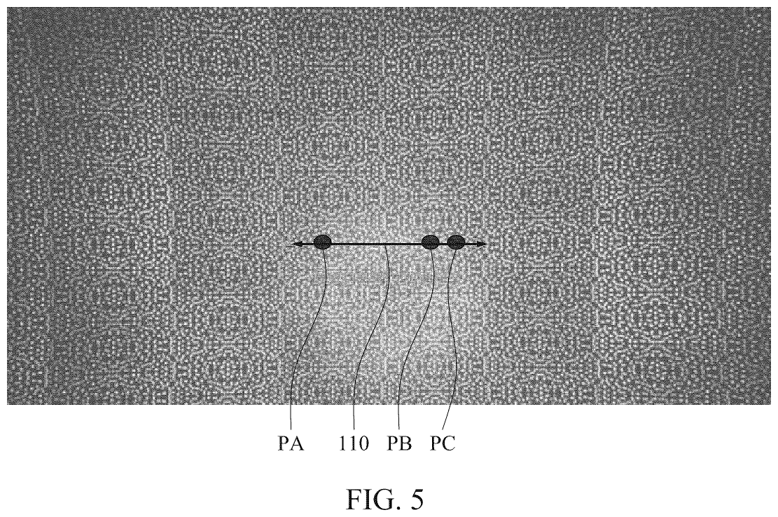

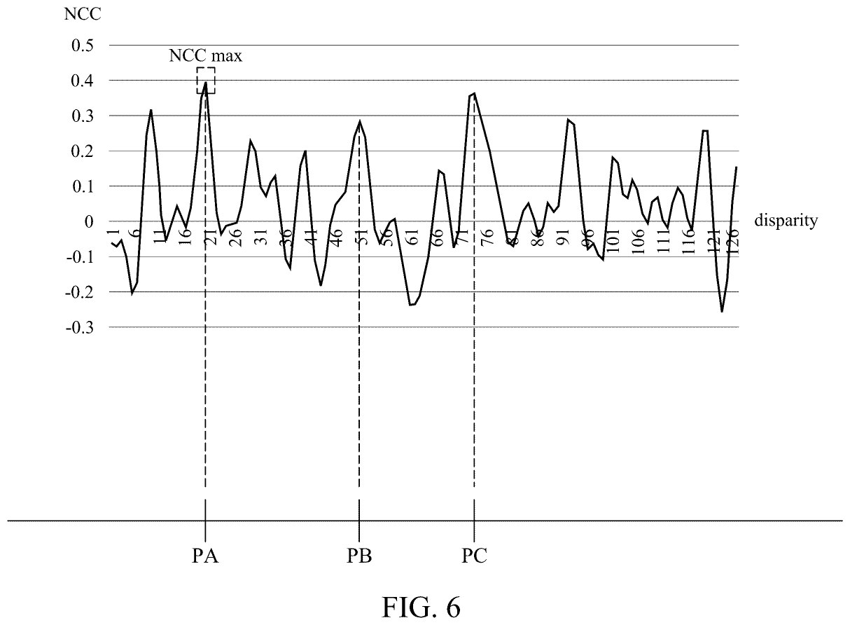

Step 410 is performed to provide a plurality of similarity values in a predetermined search range, as shown in FIG. 5. As show in FIG. 5, in this embodiment, the predetermined search range includes the area of the repeat cycle 310, and for example, positions PA, PB and PC are located therein. The predetermined search range is adapted for a disparity search performed by the structure light depth sensing circuit 120. Therefore, all potions including the positions PA, PB and PC in the predetermined search range correspond to plural disparity values and corresponding similarity values. Referring to FIG. 6, FIG. 6 is a schematic diagram showing the disparity values of the positions PA, PB and PC in the predetermined search range in accordance with embodiments of the present invention. As shown in FIG. 6, the similarity value may be a normalized cross correlation (NNC) value showing a difference between a sensed pixel block of the object and a standard pixel block of a ground truth pattern, but embodiments of the present invention are not limited thereto. As shown in FIG. 6, the position PA corresponds to a disparity value 20 corresponding to a NNC value 0.4; the position PB corresponds to a disparity value 50 corresponding to a NNC value 0.29; the position PC corresponds to a disparity value 74 corresponding to a NNC value 0.35. As shown in FIG. 6, the NNC value 0.4 of the position PA is a largest similarity value in the predetermined search range. The relationship between disparities and NNC values shown in FIG. 6 can be calculated by the structure light depth sensing circuit 120.

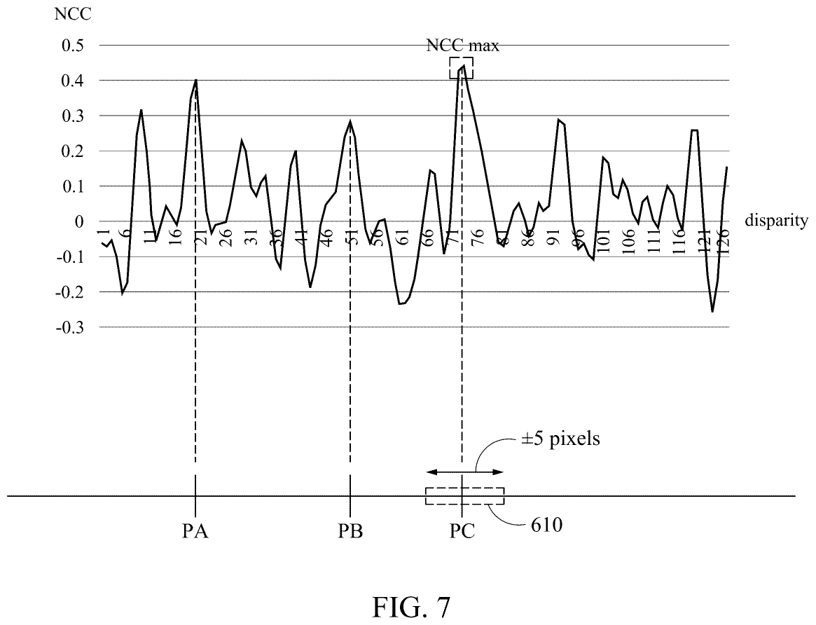

Step 420 is performed to calculate a compensation range in the predetermined search range in accordance with a target depth value of depth data of a time-of-flight depth sensing circuit 110. Specifically, after sensing the surface of the object desired to be measured, the time-of-flight depth sensing circuit 110 can obtain depth data of the surface of the object including similarity values corresponding the predetermined search range of the structure light depth sensing circuit 120. In this embodiment, a reference disparity value (for example 75) is provided the depth data of the time-of-flight depth sensing circuit 110. The reference disparity value is a correct similarity value obtained from the depth data sensed by the time-of-flight depth sensing circuit 110. For example, the time-of-flight depth sensing circuit 110 calculates a depth value for the predetermined search range, and the calculated depth value corresponds to the reference disparity value 75. In step 420, the reference disparity value is used to calculate a compensation range in the predetermined search range. In this embodiment, the compensation range is 75±5 pixels, as shown in FIG. 7. In other words, the compensation range is totally 10 pixels, but embodiments of the present invention are not limited thereto.

Step 430 is performed to calculate plural compensated similarity values in accordance with a weighting gain and the similarity values in the compensation range. In this embodiment, each of the similarity values in the compensation range is multiplied by the weighting gain to obtain the compensated similarity values. For example, the weighting gain is 1.2, and each of the NNC values located in the compensation range (for example the NNC value 0.35 of the position PC) is multiplied by 1.2. In other words, each of the NNC values located in the compensation range is compensated with the weighting gain 1.2 to obtain plural compensated similarity values. In this embodiment, the compensated NNC value (0.35*1.2) of the position PC is the maximum value among the compensated similarity values.

Step 440 is performed to determine if the maximum value among the compensated similarity values is greater than the largest similarity value. For example, the NNC value 0.4 of the position PA is the largest similarity value in the predetermined search range before the compensation of step 430 is performed. However, after the compensation of step 430 is performed, the NNC value 0.4 of the position PA may not be the largest similarity value in the predetermined search range. Therefore, step 440 is performed to determine if the maximum value among the compensated similarity values is greater than the largest similarity value 0.4 o the position PA. In this embodiment, the compensated NNC value 0.42 of the position PC is greater than the largest similarity value 0.4 of the position PA, then step 450 is performed to determine the maximum value among the compensated similarity values to be a correct similarity value, and the largest similarity value 0.4 of the position PA to be a wrong similarity value. Therefore, the disparity value 74 of the position PC is determined to be a correct disparity value to calculate the depth data.

In contrast, in step 460, if the maximum value among the compensated similarity values is not greater than the largest similarity value, the largest similarity value is determined to be a correct similarity value, and the corresponding disparity value is determined to be a correct disparity value to calculate the depth data.

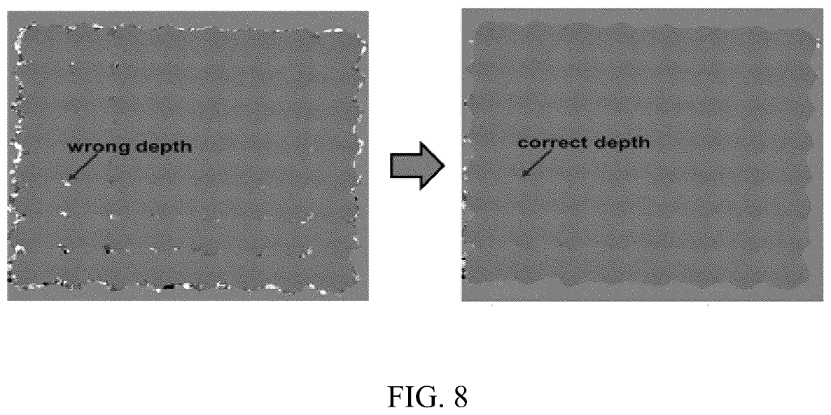

It can be understood that a conventional structure light depth sensing system may calculate a wrong similarity/disparity value for calculation of depth data with respect to patterns having repeat cycle or great height differences. In the embodiments of the present invention, the depth data of the time-of-flight depth sensing circuit 110 is used to correct calculation of the similarity/disparity value, and the problems caused by the patterns having repeat cycle or great height differences can be solved accordingly, as shown in FIG. 8.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A structure light depth sensing system using auxiliary time-of-flight sensing, comprising:
a time-of-flight depth sensing circuit configured to perform a depth sensing operation on an object to generate a depth data corresponding to plural positions on a surface of the object, wherein the depth data comprises plural depth values corresponding to positions of the object; and
a structure light depth sensing circuit configured to generate depth data corresponding to the positions on the surface of the object in accordance with the depth data of the time-of-flight depth sensing circuit, wherein the structure light depth sensing comprise a compensation circuit configured to perform:
providing a plurality of similarity values in a predetermined search range, wherein the predetermined search range comprises a largest similarity value;
calculating a compensation range in the predetermined search range in accordance with a target depth value of the depth data of the time-of-flight depth sensing circuit;
calculating plural compensated similarity values in accordance with a weighting gain and the similarity values in the compensation range; and
determining if a maximum value among the compensated similarity values is greater than the largest similarity value;
wherein when the maximum value among the compensated similarity values is greater than the largest similarity value, the maximum value among the compensated similarity values is determined to be a correct similarity value, and the largest similarity value is determined to be a wrong similarity value.

2. The structure light depth sensing system using auxiliary time-of-flight sensing of claim 1, wherein the similarity values are calculated by using normalized cross correlation (NNC).

3. The structure light depth sensing system using auxiliary time-of-flight sensing of claim 2, wherein a value of the weighting gain is substantially equal to 1.2.

4. The structure light depth sensing system using auxiliary time-of-flight sensing of claim 1, wherein when the compensation circuit performs calculating the compensated similarity values in accordance with the weighting gain and the similarity values in the compensation range, the compensation circuit performs:
multiplying each of the similarity values in the compensation range by the weighting gain to obtain the compensated similarity values.

5. The structure light depth sensing system using auxiliary time-of-flight sensing of claim 1, further comprising:
a light projector electrically connected to the time-of-flight depth sensing circuit and the structure light depth sensing circuit to be switched to provide different lights for the time-of-flight depth sensing circuit and the structure light depth sensing circuit.

6. The structure light depth sensing system using auxiliary time-of-flight sensing of claim 1, wherein the compensation range is substantially equal to 10 pixels.

7. The structure light depth sensing system using auxiliary time-of-flight sensing of claim 1, wherein when the maximum value among the compensated similarity values is not greater than the largest similarity value, the largest similarity value is determined to be a correct similarity value.

8. The structure light depth sensing system using auxiliary time-of-flight sensing of claim 1, wherein the structure light depth sensing circuit us further configured to calculate a depth value in accordance with the correct similarity value.

9. A structure light depth sensing method using auxiliary time-of-flight sensing, comprising:
providing a plurality of similarity values in a predetermined search range, wherein the predetermined search range comprises a largest similarity value;
calculating a compensation range in the predetermined search range in accordance with a target depth value of depth data of a time-of-flight depth sensing circuit;
calculating plural compensated similarity values in accordance with a weighting gain and the similarity values in the compensation range; and
determining if a maximum value among the compensated similarity values is greater than the largest similarity value;
wherein when the maximum value among the compensated similarity values is greater than the largest similarity value, the maximum value among the compensated similarity values is determined to be a correct similarity value, and the largest similarity value is determined to be a wrong similarity value.

10. The structure light depth sensing method using auxiliary time-of-flight sensing of claim 9, wherein the similarity values are calculated by using normalized cross correlation (NNC).

11. The structure light depth sensing method using auxiliary time-of-flight sensing of claim 10, wherein a value of the weighting gain is substantially equal to 1.2.

12. The structure light depth sensing method using auxiliary time-of-flight sensing of claim 9, wherein calculating the compensated similarity values in accordance with the weighting gain and the similarity values in the compensation range comprises:
multiplying each of the similarity values in the compensation range by the weighting gain to obtain the compensated similarity values.

13. The structure light depth sensing method using auxiliary time-of-flight sensing of claim 9, wherein the compensation range is substantially equal to 10 pixels.

14. The structure light depth sensing method using auxiliary time-of-flight sensing of claim 9, wherein when the maximum value among the compensated similarity values is not greater than the largest similarity value, the largest similarity value is determined to be a correct similarity value.

15. The structure light depth sensing method using auxiliary time-of-flight sensing of claim 9, further comprising:
calculating a depth value in accordance with a correct similarity value corresponding to the correct similarity value.
